(19) United States
(12) Patent Application Publication
(10) Pub. No.: US 2013/0039086 A1
(43) Pub. Date: Feb. 14, 2013

(54) HEADLAMP FOR VEHICLES

(71) Applicants: Björn Dreßler, Menden (DE); Ronny Letzin, Lippstadt (DE)

(72) Inventors: Björn Dreßler, Menden (DE); Ronny Letzin, Lippstadt (DE)

(73) Assignee: Hella KGaA Hueck & Co., Lippstadt (DE)

(21) Appl. No.: 13/569,323

(22) Filed: Aug. 8, 2012

(30) Foreign Application Priority Data
Aug. 8, 2011 (DE) 10 2011 052 488.6

(51) Int. Cl. B60Q 1/04; F21V 13/04

(52) U.S. Cl. 362/516

(57) ABSTRACT

The invention concerns a headlamp for vehicles with a housing, which provides a light module containing a light source, a reflector assigned to the light source, a lens located in front of the reflector and a shutter located between the lens and the reflector whereas in an area above the shutter a diffuser lens element for scattering a light beam emitted directly by the light source shall be located.

### CROSS REFERENCE

This application claims priority to German Patent Application No. 10 2011 052 488.6, filed Aug. 8, 2011, pursuant to 35 U.S.C. §119 and 37 C.F.R. 1.55. The foregoing German patent application is hereby incorporated by reference in its entirety.

### TECHNICAL FIELD OF INVENTION

The invention concerns a vehicle headlamp with housing which provides a light module containing one light source, one reflector assigned to the light source, a lens located in front of the reflector and a shutter located between the lens and the reflector.

### BACKGROUND OF INVENTION

A headlamp for motor vehicles operating according to the projector-type system is known from EP 2 157 362 A1. This headlamp has a light source, a reflector, a lens located in front of the reflector as well as a shutter located in the focal point area of the lens. The shutter has a shutter drum that runs transversely to the optical axis of the headlamp and comprises a shutter edge for generating a given light distribution. If an LED is used as a light source, non-uniform light distribution as well as exceeding photometric limit values can occur due to a light beam directly emitted outward by the LED light source. If the lens is cut correspondingly or an additional shutter is inserted into the area of direct light emission in order to avoid such an unwanted effect the headlamp efficiency will decrease or there will be a relatively high gradient in the edge area of the light distribution.

### SUMMARY OF INVENTION

The task of the present invention is to advance a projector-type headlamp design for vehicles such that a homogeneous light distribution (for road illumination) is ensured in a simple and cost-effective manner while maintaining the highest possible efficiency at the same time.

As a solution to this task, the invention is characterized in that that a diffuser lens element for diffusing a light beam directly emitted by the light source shall be located in an area above the shutter.

The particular benefit of the invention consists in the fact that by placing a diffuser lens element in the beam path of the light beam emitted by the light source into the immediate surroundings, a vertical and/or horizontal distribution of the (direct) light beam is achieved which leads to a homogenization of the resulting light distribution at a relatively high efficiency. The underlying principle behind the invention is to make the existing direct flux of the light source usable for the resulting light distribution in order to comply with the rigid regulatory approval requirements while maintaining a high efficiency.

In a preferred embodiment of the invention, the diffuser lens element shall enable the diffusion of the light beam directly emitted by the light source which shall achieve a homogenization in particular in a lower edge area of the light distribution. The resulting light distribution shall preferably be produced by superimposing a partial light distribution, determining the light shape, which shall be generated by the light module with diffuser lens element, and a base light distribution which shall shape the close-up field light and is generated by a separate base light module. The benefit of the invention is thus an improved linkage of the partial light connection of the invented light module to the base light distribution of a base light module.

In a further development of the invention, the diffuser lens element shall be attached to a shutter support holding the shutter using a carrier frame. The advantage of this is a simplified attachment.

Further advantages of the invention result from the other dependent claims.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Following, an embodiment example of the invention will be discussed in more detail with reference to the drawings.

The following is shown:

FIG. 1 a perspective view of a diffuser lens element for the invented headlamp,

FIG. 2 a perspective front view of a shutter with a headlamp diffuser lens element attached to the shutter,

FIG. 3 top view of the shutter with diffuser lens element,

FIG. 4a a schematic depiction of a light distribution without diffuser lens element, and

FIG. 4b a schematic depiction of a light distribution with diffuser lens element.

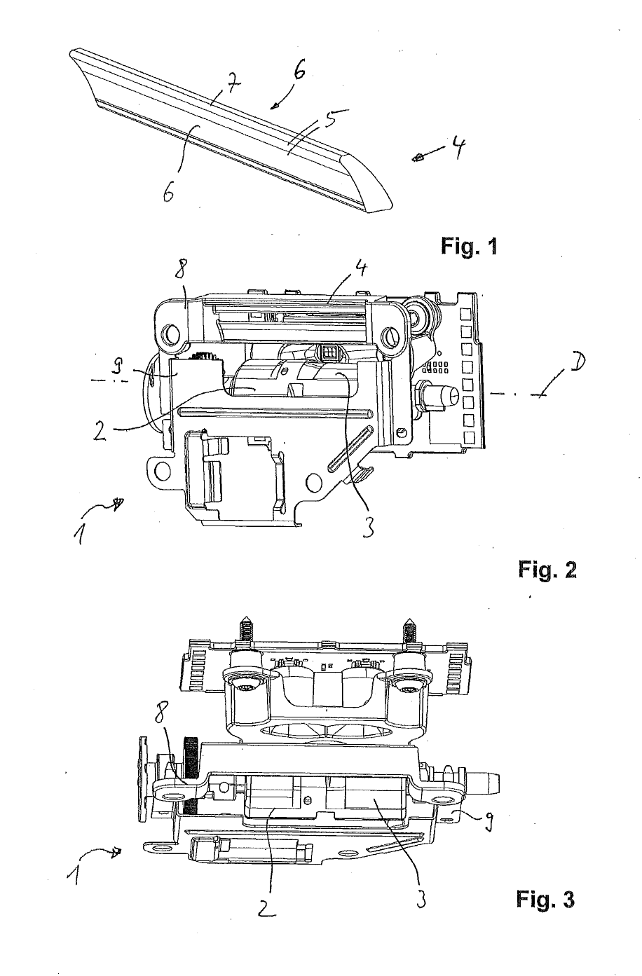

### DETAILED DESCRIPTION

A headlamp for vehicles usually has a pot-shaped housing which contains a light source (LED), a reflector assigned to the light source, a lens located in front of the reflector and a shutter 1 located between the lens and the reflector. The resulting light module operates in accordance to the projector principle and produces a given light distribution.

FIGS. 2 and 3 show better that shutter 1 has a shutter drum 2 which runs transversely to the optical axis of the headlamp and can be rotated around a rotation axis D running vertically to the optical axis and in horizontal direction. The shutter drum 2 has at least one shutter edge 3 by the means of which a cut-off line for a given light function such as motorway light, town light, country light as well as low or high beam can be generated.

The embodiment example shown here produces the light distribution superimposing a partial light distribution which determines the light function or the cut-off line of the light function and shall be produced by the light module using shutter 1, over a base light distribution (generated by another base light module not depicted here) for close-up illumination. Another LED light source and a reflector can form, for example, the base light module which shall preferably be located in the same headlamp housing as the light module with shutter 1.

The light module with shutter 1 can alternatively also be used separately for producing the resulting light distribution.

For homogenizing the (direct) light which is immediately directed to a clear lens covering the headlamp housing aperture, a diffuser lens element 4 is located in an area above shutter 1. The diffuser lens element 4 is embodied as an elongated prismatic lens system with multiple stages 5 preferably located on the front side facing the lens. The cross-section of the diffuser lens element 4 is triangular and has flat sides 6 which are located opposite to each other and shall taper to a longitudinal edge 7. The diffuser lens element 4 is located transversely to the optical axis and parallel to the shutter drum 2.

The diffuser lens element 4 is made of a transparent plastic or glass material. It is attached by interlocking and/or force-fit connection to a carrier frame 8 which in turn attaches to a shutter support 9 holding the shutter drum 2.

The diffuser optics element 4 is located in vertical direction above shutter 1. Alternatively, the diffuser lens element 4 may be positioned closer or further away from the LED light source. Correspondingly, the effective surface area of the diffuser lens element may then be designated smaller or larger.

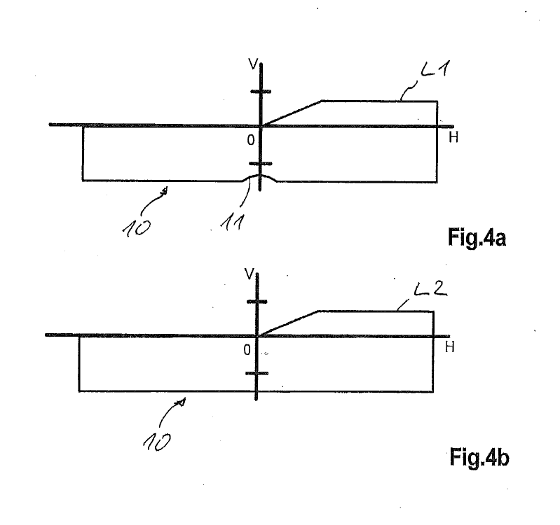

Within the headlamp housing, the diffuser lens element 4 is located in the beam path of the light/light beam directly emitted by the LED light source. If the light module was operated without the diffuser lens element 4 a light distribution L1 according to FIG. 4a would be the result for generating the low beam function. This distribution has a constriction 11 at its lower edge 10 which shall produce shadows in the close-up area (road).

Integrating the diffuser optics element 4 into the light module will yield the resulting light distribution L2 for generating the low beam function according to FIG. 4b where no constriction at the lower edge 10 of light distribution L2 occurs. The lower edge 10 will have a light distribution with a relatively low gradient instead. In particular, the invented diffuser lens element 4 enables a homogeneous transition from the partial light distribution produced by the light module to the base light distribution generated by the base light module.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiments, but should be defined only in accordance with the following claims appended hereto and their equivalents.

### LIST OF REFERENCE SYMBOLS

1 Shutter

2 Shutter drum

3 Shutter edge

4 Diffuser lens element

5 Stages

6 Flat sides

7 Longitudinal edge

8 Carrier frame

9 Shutter support

10 Lower edge

11 Constriction

D Rotation axis

L1 Light distribution

L2 Resulting light distribution

1. A headlamp for vehicles with a housing, which provides a light module containing at least one light source, at least one reflector assigned to the light source, a lens located in front of the reflector(s) and a shutter located between the lens and the reflector, characterized in that that in an area above the shutter a diffuser lens element for scattering a light beam emitted directly by the light source shall be located.

2. The headlamp according to claim 1, characterized in that that the diffuser lens element shall diffuse the light beam directly emitted by the light source of the light module to a partial light distribution in a way that a resulting light distribution for generating a given lighting function shall be homogenized in an area at the lower edge.

3. The headlamp according to claim 1, characterized in that that the diffuser lens element shall diffuse the light beam directly emitted by the light source of the light module to a partial light distribution in a way that a resulting light distribution for generating a given lighting function shall be homogenized horizontally in an area at the lower edge.

4. The headlamp according to one of claim 1, characterized in that that a given light distribution shall be produced by superimposing a base light distribution generated by a base light module for close-up illumination and a partial light distribution generated by the light module for determining the given light function.

5. The headlamp according to one of claim 1, characterized in that that the shutter shall comprise a shutter drum to be rotated around a rotation axis running vertically to an optical axis and shall have a number of shutter edges for generating various light functions.

6. The headlamp according to one of claim 5, characterized in that that the shutter drum be able to be rotated and attached to a shutter support.

7. The headlamp according to one of claim 6, characterized in that that the diffuser lens element shall be attached to the stationary shutter support by a carrier frame.

8. The headlamp according to one of claim 5, characterized in that that the diffuser lens element shall be arranged in vertical direction above the shutter drum.

9. The headlamp according to one of claim 1, characterized in that that the diffuser lens element shall be designed as an elongated prismatic lens system and possess multiple stage.

10. The headlamp according to one of claim 1, characterized in that that the diffuser lens element shall be tapered along a longitudinal edge of said element.
